(19) United States
(12) Patent Application Publication
(10) Pub. No.: US 2016/0176639 A1
(43) Pub. Date: Jun. 23, 2016

(54) AN ARTIFICIAL RETAINING DAM OF COAL MINE UNDERGROUND RESERVOIR AND METHOD FOR CONNECTING SECURITY COAL PILLAR, SURROUNDING ROCK WITH THE RETAINING DAM

(71) Applicant: CHINA SHENHUA ENERGY COMPANY LIMITED, Beijing (CN)

(72) Inventors: Dazhao Gu, Beijing (CN); Quansheng Li, Beijing (CN); Sushe Chen, Beijing (CN); Kai Zhang, Beijing (CN)

(21) Appl. No.: 14/910,149

(22) PCT Filed: Apr. 10, 2014
(86) PCT No.: PCT/CN2014/075084

§ 371 Date: Feb. 4, 2016

(30) Foreign Application Priority Data
Aug. 14, 2013 (CN) 201310354100.X

(51) Int. Cl. B65G 5/00

(52) U.S. Cl. CPC B65G 5/00

(57) ABSTRACT

The present disclosure provides an artificial retaining dam of coal mine underground reservoir. The artificial retaining dam (30) is embedded into a security coal pillar (2) and surrounding rock (3) around an auxiliary roadway (1), the cross section of the artificial retaining dam (30) is an arc, and a concave of the arc artificial retaining dam (30) faces the underground reservoir. The disclosure also disclosed a method for connecting a security coal pillar, surrounding rock, and an artificial retaining dam for a coal mine underground reservoir. The retaining dam improves sliding-resistant performance of an artificial retaining dam, and can effectively cushion the impact to the dam bodies due to suddenly increased water pressure.

### TECHNICAL FIELD

The present disclosure relates to coal mining and hydraulic engineering, and particularly an artificial retaining dam of coal mine underground reservoir and a method for connecting security coal pillar, surrounding rock with retaining dam.

### BACKGROUND ART

In China, Shanxi Province, Shaanxi Province, Inner Mongolia, Ningxia Province, and Gansu Province constitute an energy “Golden Triangle” region. The coal resource of the energy “Golden Triangle” region is characterized by shallow depth of embedment, thin bedrock, and thick coal seam, etc. In 2011, the coal production of this area reached 2.382 billion tons, accounting for 67.7% of the overall coal production in China. This area has become a major coal production area of China. However, the energy “Golden Triangle” region in western China has a fragile ecosystem. This region is exceptionally dry with scare and the water resource thereof is unevenly distributed, by location and season. For instance, the northern part of Shaanxi province is an inland area with little rainfall and high evaporation, and its per capita water resource is merely 927 m³, accounting for 35.7% of the average water resource per capita in China. Therefore, the northern part of Shaanxi province is a typical region with a severe water-shortage.

It is unavoidable that large-scale and intensive coal mining in this region will have negative impact on water resources in this region. The movement and storage state of surface and underground water can be affected by coal mine roadways and goafs the circulation of the underground water has been changed, for example, dried-up river streams, decline of water table, and drastic decrease or drying up of spring-water. Currently, an important technology is to drain mine water. However, drainage of mine water has numerous disadvantages, one of which is to produce extreme waste of water resource, and another of which is to pose a severe pollution to the local ecosystem.

Therefore, the key challenge related to water-preserving mining in the energy “Golden Triangle” region is how to prevent the mine water being drained. Goafs formed by underground mining can be used to store mine water, so as to construct underground reservoirs. If this storage is supplemented by engineering measures for filtering underground water resources, the stored water can be utilized by connecting the reservoirs to the ground surface by drilling holes. If so, the water resources can be used effectively in the future. Artificial retaining dams are located where ventilation roadways, transport roadways and main roadways of the goafs constituting the coal mine underground reservoir are interconnected, which is important for constructing the reservoir. The contact site between the artificial retaining dam and security coal pillar is a weakness for the retaining dam. It is a key factor for constructing the artificial retaining dam to improve the sliding-resistant performance of the retaining dam by a reasonable design, which is important for the safety of the reservoir.

Currently, there is no technique or instance for constructing the contact sites between an artificial retaining dam of coal mine underground reservoir and a security coal pillar. It is difficult to notch in the narrow location in wells and control grouting. Therefore, it is necessary to design an artificial retaining dam of coal mine underground reservoir which improves the sliding-resistant performance of the artificial retaining dam.

### SUMMARY

It is an object of the present disclosure to overcome the disadvantages of the prior art, and to provide an artificial retaining dam of coal mine underground reservoir which can improve the sliding-resistant performance of the artificial retaining dam, and a method for connecting security coal pillar and surrounding rock with the artificial retaining dam.

A technical solution of the present disclosure thus provides an artificial retaining dam of coal mine underground reservoir, wherein the artificial retaining dam is embedded into a security coal pillar and a surrounding rock around an auxiliary roadway, the cross section of the artificial retaining dam is arc-shaped, and the concave of the arc-shaped artificial retaining dam faces the underground reservoir.

Preferably, the artificial retaining dam is embedded into the security coal pillar in the depth of 50-80 cm of the security coal pillar, and the artificial retaining dam is embedded into the surrounding rock in the depth of 30-60 cm of the surrounding rock.

Preferably, a plurality of bolts are provided between the artificial retaining dam and the security coal pillar, and a plurality of bolts are provided between the artificial retaining dam and the surrounding rock.

Preferably, the length of the bolts is 180-210 cm, the depth of the bolts inserted into the security coal pillar is 50-80 cm, and the depth of the bolts inserted into the surrounding rock is 30-60 cm.

Preferably, monitors for monitoring stress, strain and displacement are mounted where the artificial retaining dam contacts with the security coal pillar and the surrounding rock.

Another technical solution of the present disclosure also provides a method for connecting artificial retaining dam of coal mine underground reservoir with security coal pillar and surrounding rock, the method comprising the steps of: selecting damming positions of the artificial retaining dam between the security coal pillar in the auxiliary roadway; setting the cross section of the artificial retaining dam as an arc-shape dam, the concave of the arc-shape facing the underground reservoir; notching in the security coal pillar and the surrounding rock around the auxiliary roadway to form recesses; in the recesses, inserting a plurality of bolts into the security coal pillar and the surrounding rock; and ejecting concrete with high pressure to form the artificial retaining dam in the recesses.

Preferably, the step of selecting damming positions of the artificial retaining dam comprises: prospecting the rock-coal property, stratum, and structure of the roadway to be constructed with geophysical prospecting and drilling means; selecting locations with simple structure and stable rock-coal property as damming positions of the artificial retaining dam.

The present disclosure has the following beneficial effects by adopting the above technical solutions: enhancing the connection between the artificial retaining dam and the security coal pillar, the surrounding rock, and improving the sliding-resistant performance of the artificial retaining dam due to the embedment of the artificial retaining dam into the security coal pillar and the surrounding rock.

### BRIEF DESCRIPTION OF THE DRAWINGS

FIG. 1 is a structural diagram of an underground reservoir according to an embodiment of the present disclosure.

FIG. 2 is a structural diagram of an artificial retaining dam according to an embodiment of the present disclosure.

FIG. 3 is a cross sectional view taking along A-A of FIG. 2. Reference number list 1-auxiliary roadway 2-security coal pillar 3-surrounding rock 4-goaf 5-main roadway 11-connecting roadway 30-artificial retaining dam 31-bolt 32-recess

### DETAILED DESCRIPTION OF THE EMBODIMENTS

Hereinafter, the embodiments of the present disclosure are further described with reference to the accompanying drawings.

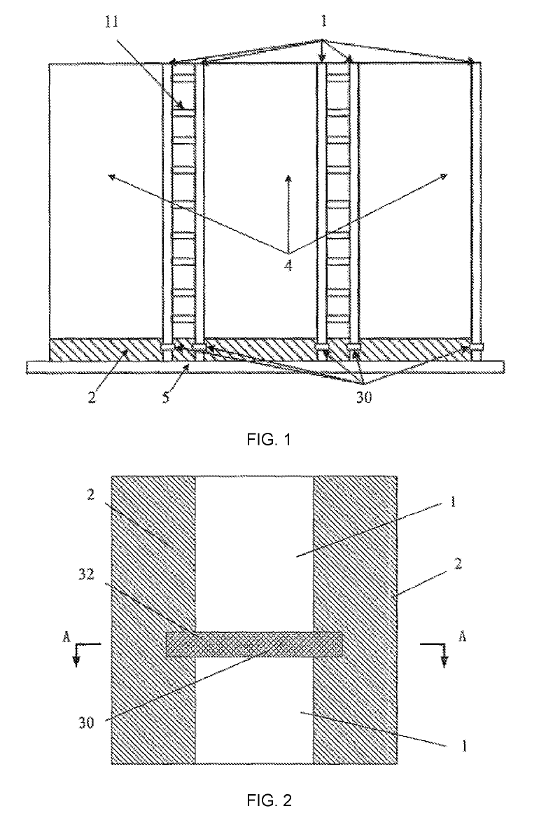

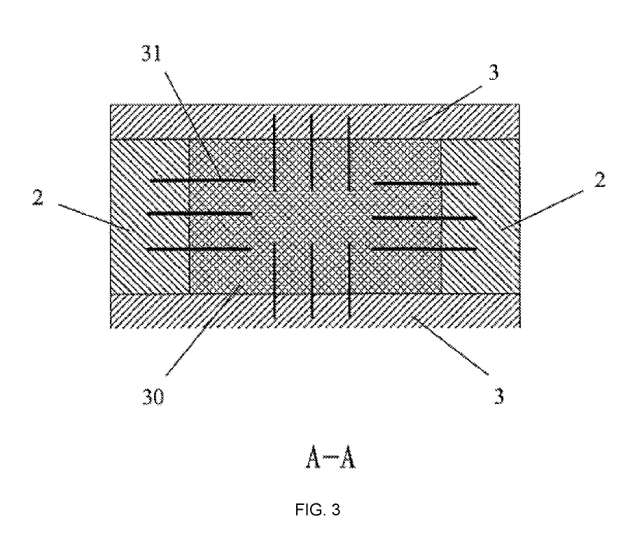

As shown in FIG. 1, security coal pillars 2 are portions of ore bodies which are not mined temporarily or are preserved for protecting ground surface landforms, buildings, constructions and major roadways from collapsing, and for isolating ore fields, coalfields, aquifers, fire zones, fracture zones, etc. The security coal pillars 2 play a supporting role, and are located on left and right sides of an auxiliary roadway 1. Surrounding rocks 3 (see FIG. 3) are formed during the auxiliary roadway 1 is being drilled. The surrounding rocks 3 are located on upper and lower sides of the auxiliary roadway 1. A connecting roadway 11 communicates adjacent auxiliary roadways 1 with each other. When a goaf 4 is formed after a working face is mined, overlying strata of the auxiliary roadway 1 caves, and the auxiliary roadway 1 and the goaf 4 together form an underground reservoir. In the present disclosure, security coal pillars 2 are located between the underground reservoir and a main roadway 5, and a portion of dam body of the underground reservoir is formed by security coal pillars 2. Since the auxiliary roadway 1 is communicated with the main roadway 5, only positions between the auxiliary roadway 1 and the main roadway 5 need to be plugged.

As shown in FIG. 2, an artificial retaining dam 30 of the coal mine underground reservoir according to the present disclosure is embedded into the security coal pillar 2 and the surrounding rocks 3 around the auxiliary roadway 1. The artificial retaining dam 30 has a good anti-seepage performance. More importantly, the artificial retaining dam 30 is embedded into the security coal pillars 2 on left and right sides of the auxiliary roadway 1 and the surrounding rocks 3 on upper and lower sides of the auxiliary roadway 1, so as to improve the sliding-resistant performance of the artificial retaining dam.

In the present embodiment, as shown in FIGS. 2-3, the artificial retaining dam 30 is embedded into the security coal pillar 2 in the depth of 50-80 cm of the security coal pillar 2, and the artificial retaining dam 30 is embedded into the surrounding rock 3 in the depth of 30-60 cm of the surrounding rock 3. The direction of the above-mentioned depths is the same as the direction of the width of the artificial retaining dam 30. There are three bolts 31 between the artificial retaining dam 30 and the security coal pillar 2, and there are also three bolts 31 between the artificial retaining dam 30 and the surrounding rock 3. The number of the bolts 31 may also be more than three. A plurality of the bolts 31 are spaced apart from one another. The distance between adjacent bolts 31 may be 20 cm. The length of one bolt is 180-210 cm. The depth of the bolts 31 inserted into the security coal pillar 2 is 50-80 cm. The depth of the bolts 31 inserted into the surrounding rock 3 is 30-60 cm. The bolts 31 should keep upright, so as to ensure good stability. The bolts 31 may be supported by rebars, for connecting the artificial retaining dam 30 with the security coal pillar 2 or the surrounding rock 3, so as to further improve the sliding-resistant performance of the artificial retaining dam.

In the present embodiment, as shown in FIG. 2, the cross section of the artificial retaining dam 30 is rectangular.

Preferably, the cross section of the artificial retaining dam may also be arc-shaped, wherein the concave of the arc-shaped artificial retaining dam faces the underground reservoir, so as to cushion the impact to the dam body due to suddenly increased water pressure.

Preferably, in order to ensure the safety of the artificial retaining dam, monitors for monitoring stress, strain and displacement are mounted where the artificial retaining dam 30 contacts with the security coal pillar 2 and the surrounding rock 3. The output of the monitor is transferred in real time to a ground monitor center via a coal-mine communication cable, in order to prevent dam break. Typically, each side is provided with a monitor. More monitors may need to be mounted as required.

The method for connecting artificial retaining dam for coal mine underground reservoir with security coal pillars and surrounding rocks comprises the steps of:

Step 101: selecting damming positions of the artificial retaining dam 30 between the security coal pillars in the auxiliary roadway;

Step 102: notching in the security coal pillar 2 and the surrounding rock 3 around the auxiliary roadway 1 to form recesses 32;

Step 103: in the recesses 32, inserting a plurality of bolts 31 into the security coal pillar 2 and the surrounding rock 3;

Step 104: ejecting concrete with high pressure to form the artificial retaining dam 30 in the recesses 32.

FIG. 2 shows the recess 32 formed in the security coal pillar 2. The depth of the recess 32 may be 30-80 cm, and the depth may be adjusted according to surrounding geological conditions and the capacity of the underground reservoir. Specifically, the depth of the recess 32 of the security coal pillar 2 may be 50-80 cm, and the depth of the recess 32 of the surrounding rock 3 may be 30-60 cm. The advantage of the connecting method according to the present disclosure is the same as that of the artificial retaining dam 30, and thus will not be discussed hereinafter.

Preferably, step 101 of selecting the damming positions of the artificial retaining dam further comprises:

Step 201: prospecting the rock-coal property, stratum, and structure of the roadway to be constructed by using geophysical prospecting and drilling means; and

Step 202: selecting locations with simple structure and stable rock-coal property as damming positions for the artificial retaining dam.

Preferably, before step 102 of “notching in the security coal pillar 2 and the surrounding rock 3 around the auxiliary roadway 1 to form recesses 32”, the method further comprises:

Step 301: estimating the water pressure in the auxiliary roadway 1; and

Step 302: setting the shape of the cross section of the artificial retaining dam according to the water pressure.

It is preferable to select an artificial retaining dam with arc-shaped cross section, when the water pressure is relatively high, or when the artificial retaining dam is located in a lower part of the reservoir, so as to cushion impact due to the water pressure. For arc-shaped artificial retaining dam, the recess 32 is also formed as an arc.

By designing the connecting sites for connecting the artificial retaining dam with the security coal pillar and the surrounding rock, an artificial retaining dam with good sliding-resistant performance is obtained, and thus the safety of the underground reservoir is ensured. Any emergency can be handled by means of monitors for monitoring the underground reservoir in real time. It is advantageous to store mine well water in the mine well, prevent mine well water being discharged and evaporated, and realize protection for coal mining underground water resource.

The above content only describes the principle and the preferred embodiments of the present disclosure. It should be pointed out that on the basis of the principle of the present disclosure, those skilled in the art can make some variations which also fall into the protection scope of the present disclosure.

1. An artificial retaining dam of coal mine underground reservoir, wherein the artificial retaining dam is embedded into security coal pillars and surrounding rocks around an auxiliary roadway, the cross section of the artificial retaining dam is arc-shaped, and the concave of the arc-shaped artificial retaining dam faces the underground reservoir.

2. The artificial retaining dam according to claim 1, wherein the artificial retaining dam is embedded into the security coal pillars in the depth of 50-80 cm of the security coal pillars, and the artificial retaining dam is embedded into the surrounding rocks in the depth of 30-60 cm of the surrounding rocks.

3. The artificial retaining dam according to claim 1, wherein a plurality of bolts are provided between the artificial retaining dam and the security coal pillars, and a plurality of bolts are also provided between the artificial retaining dam and the surrounding rocks.

4. The artificial retaining dam according to claim 3, wherein the length of the bolts is 180-210 cm, the depth of the bolts inserted into the security coal pillars is 50-80 cm, and the depth of the bolts inserted into the surrounding rocks is 30-60 cm.

5. The artificial retaining dam according to claim 1, wherein monitors for monitoring stress, strain and displacement is mounted where the artificial retaining dam contacts with the security coal pillars and the surrounding rocks.

6. A method for connecting artificial retaining dam of coal mine underground reservoir with security coal pillars and surrounding rocks, the method comprising the steps of:
selecting damming positions of the artificial retaining dam between the security coal pillars in the auxiliary roadway;
setting the cross section of the artificial retaining dam as an arc-shape, the concave of the arc-shape facing the underground reservoir;
notching in the security coal pillars and the surrounding rocks around the auxiliary roadway to form recesses;
in the recesses, inserting a plurality of bolts into the security coal pillars and the surrounding rocks; and
ejecting concrete with high pressure to form the artificial retaining dam in the recesses.

7. The method according to claim 6, wherein the step of selecting damming positions of the artificial retaining dam comprises:
prospecting the rock-coal property, stratum, and structure of the roadway to be constructed by using geophysical prospecting and drilling means;
selecting locations with simple structure and stable rock-coal property as damming positions of the artificial retaining dam.
